(19) United States
(12) Patent Application Publication
(10) Pub. No.: US 2013/0284712 A1
(43) Pub. Date: Oct. 31, 2013

(54) AUTOMATON FOR RAIL MAINTENANCE, AND IMPLEMENTATION METHOD

(71) Applicant: Jean Sauron, Draveil (FR)

(72) Inventor: Jean Sauron, Draveil (FR)

(73) Assignee: CTF FRANCE, Bondoufle Cedex (FR)

(21) Appl. No.: 13/978,586

(22) PCT Filed: Jan. 6, 2012
(86) PCT No.: PCT/EP2012/050183

§ 371 Date: Jul. 8, 2013

(30) Foreign Application Priority Data
Jan. 6, 2011 (FR) 1150105

(51) Int. Cl. B23K 9/095

(52) U.S. Cl. CPC B23K 9/095
USPC 219/125.1

(57) ABSTRACT

An arc welding automat for maintaining or repairing rails and switch gears includes a frame, a welding device including a torch for welding an area of a rail, the frame being provided with at least two elements for the support on a rail or a switch gear, these two elements and the torch being substantially aligned, the torch including an element of displacement on at least two horizontal axes. The automat includes an element for performing steps of:—storing, in a reference system having at least two dimensions, space coordinates of points forming at least two polygons defining at least two distinct working surfaces inside an area to be welded;—implementing a welding program including moving the torch with respect to the frame, so as to intervene successively on all the distinct working surfaces. Also disclosed is a welding method for maintaining or repairing rails and switch gears.

The present invention refers to the maintenance and the repair of worn rails, for example of rails for rail traffic networks.

More precisely, the present invention refers to a method for repairing and maintaining rails and switch gears, as well as an apparatus provided with means for implementing said method.

The circulation of vehicles such as trains implies the wear of the rails supporting them. This wear appears for example in form of scratches or recesses in the surface of the rails. In order to keep the railways in a good operating condition, it is advisable to fill these scratches or recesses.

In order to maintain rails, it is known to use in particular automats especially designed for repairing these recesses, by filling them with a welding material.

For example, patent EP 1 145 793 describes an arc welding automat for maintaining rails. This automat comprises a frame, a welding device including a torch for welding a rail area, as well as a control unit.

The welding material the torch is supplied with is formed by core welding wires. Core welding wires are long elements including a filler metal for arc welding. A wire typically includes a metal sheath surrounding a core made up of pulverized minerals. When welding, the sheath melts and mixes with the core, which includes for example antioxidants or metal additives for providing the weld with some physical properties. Between the core and the sheath there may be a gas for making the welding operation better.

According to patent EP 1 145 793, the welding torch is provided with means of displacement in the direction of two axes in a horizontal plane. This mobility in two dimensions allows a welding method comprising a step of manually storing the co-ordinates of at least three points, defining a rail surface to be repaired, then a step during which the automat performs this repair.

However, it happens that a rail portion comprises a plurality of small worn areas requiring a repair, but it is not necessary to treat said portion in its entirety.

The present invention makes it possible to solve this problem by proposing a welding method for a localized area of a rail or a switch gear, the method including the following steps of:
positioning an arc welding automat along at least one rail or switch gear, said apparatus including a frame and a welding torch supplied with core welding wires, said torch being provided with means of displacement in the direction of at least two dimensions with respect to the frame;
placing the torch at a reference position with respect to the area to be welded;
storing, in a reference system having at least two dimensions, the space co-ordinates of at least two polygons, defining at least two distinct working surfaces inside the area to be welded;
stating a welding program including a displacement of the torch with the respect to the frame, so as to intervene successively on all said distinct working surfaces.

Another object of the invention is also an arc welding automat for implementing such a method. More precisely, the invention refers to an arc welding automat for maintaining or repairing rails and switch gears, the automat including a frame, a welding device including a torch for welding a rail area, the frame being provided with at least two support means for providing a support on a rail or a switch gear, these two means and the torch being substantially aligned, the torch including means of displacement on at least two horizontal axes, the automat being characterized in that it is provided with means for performing the following steps of:
storing in a reference system having at least two dimensions space co-ordinates of at least two polygons defining at least two distinct working surfaces within an area to be welded;
implementing a welding program including a displacement of the torch with respect to the frame, so as to intervene successively on all said distinct working surfaces.

Most surfaces of rails or switch gears having damages are substantially arranged in a horizontal plane. However, some parts of a switch gear, in particular the ends of track crossings, have three-dimensional surfaces. It is thus advisable to modify the height of the torch during an operation.

For this purpose, according to a preferential embodiment of the invention, the torch is provided with means of displacement in three dimensions with respect to the frame and the space co-ordinates of the working areas are defined in a three-dimensional reference system.

A welding operation is preferentially performed by successively depositing bands of welding material, these bands being called weld seams.

According to an embodiment of the invention, the deposition of weld seams is carried out by moving the torch in a rectilinear way, in the direction of an axis whose co-ordinates can be chosen by the operator. According to an alternative embodiment, the torch is moreover moved along a sinusoidal path around a main axis of displacement. Weld seams are obtained which have a waved, toothed or crenellated shape.

Some rails and/or switch gears, in particular out of cast manganese steel, require a relatively low temperature, in particular lower than 250° C., in order to keep their mechanical properties. It is thus important, in the welding method used, to prevent the metal of the rail from being heated at too high a temperature.

A particular embodiment of the invention makes it possible to solve this problem. According to this embodiment, the welding program comprises the following steps in which:
the torch deposits successively a first weld seam onto each distinct working surface;
then the torch deposits successively another weld seam onto each said working surface that is not entirely covered;

said last step being repeated as long as at least one of the working surfaces is not entirely covered.

This method of depositing one weld seam after another prevents the metal from being locally overheated during a welding operation. Such an overheating could take place on a surface entirely treated before the passage to a distinct surface. The successive treatment of each working surface, one weld seam after another, enables each weld seam to cool before depositing a juxtaposed weld seam.

The invention will be better understood when reading the following description and examining the annexed figures. Those are given as an indication and by no means a restriction of the invention. The figures show:

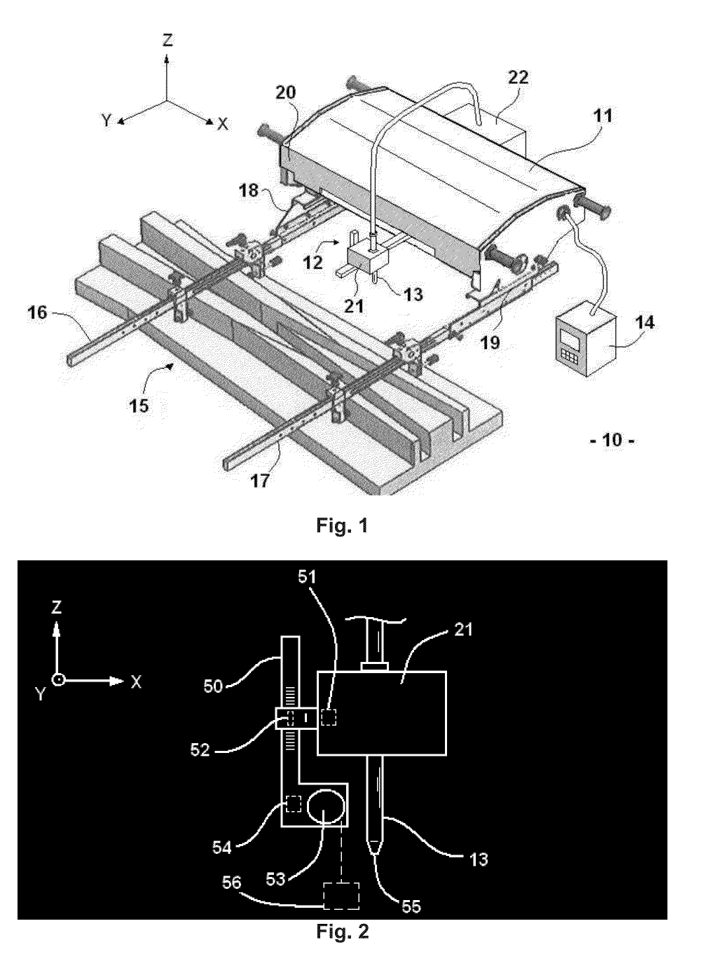

FIG. 1: a perspective view of an automat according to an embodiment of the invention;

FIG. 2: a schematic view of an element of the automat represented in FIG. 1;

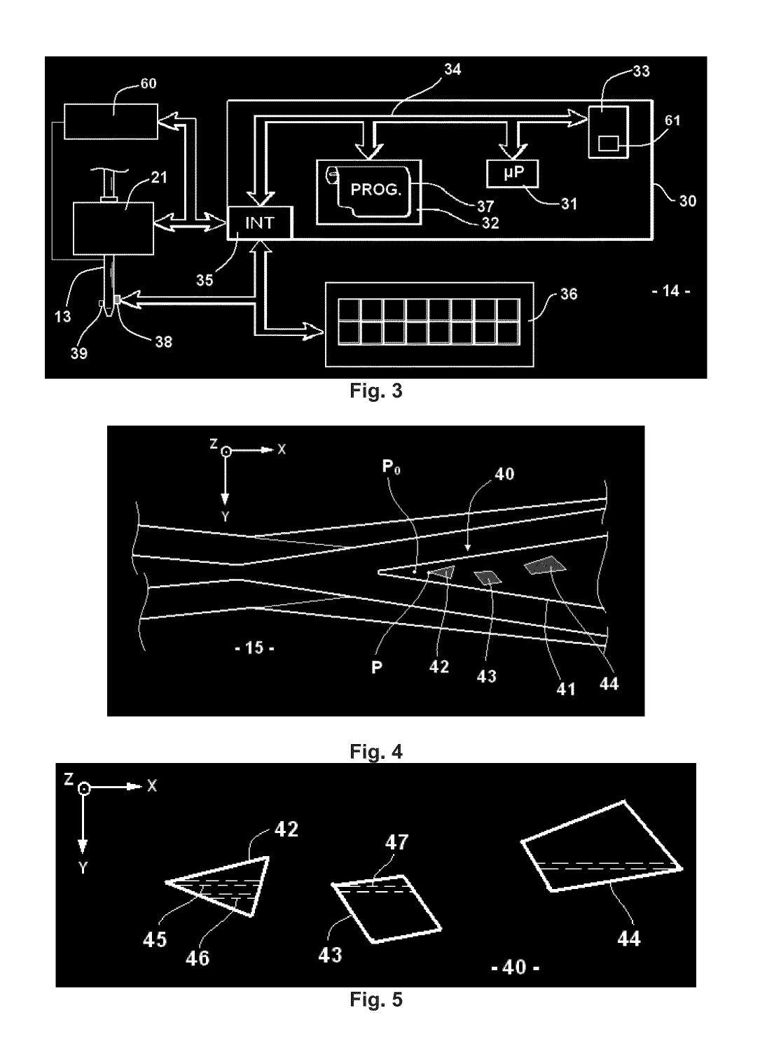

FIGS. 3 and 4: schematic views of a working area of the automat represented in FIG. 1.

FIG. 1 represents a perspective view of an automat 10 according to an embodiment of the invention. The automat 10 comprises in particular a frame 11, a welding device 12 including in particular a torch 13, as well as a unit 14 for driving and controlling the welding operation.

In FIG. 1, the automat is represented in position on a switch gear 15 to be repaired.

The frame 11 has substantially the form of a right-angled parallelepiped. For intelligibility purposes, right-angled coordinates are used which comprise three axes (X, Y, Z) represented in FIG. 1. The edges of the frame 11 are substantially oriented in the direction of the axes (X, Y, Z). the axis Z represents the vertical, the axis X is substantially parallel to an axis of rolling on the switch gear 15.

The automat 10 is provided with two locking means intended to lock said automat on the switch gear 15 to be repaired. In the example represented in FIG. 1, each of these means comprises a horizontal bar (16, 17), substantially arranged in the direction of the axis Y and provided with a sliding vice device. The vice can be pressed against both sides of the switch gear 15, in order to fix each bar (16, 17) on the switch gear. The frame 11 is provided with shoes (18, 19) which enable an operator to make said frame slide on the bars (16, 17), so as to suitably position the welding device 12 above the switch gear 15, before starting the automat.

According to the configuration of the rail or switch gear to be repaired, other means for locking the automat on said rail or switch gear can be used. The locking means described in document EP 1 145 793 can be used in particular within the framework of this invention.

As a result of the configuration of the locking means (16, 17), the frame 11 is overhanging with respect to the switch gear 15. The welding device 12 is located at a side face 20 of the frame, said face being substantially arranged in the direction of the axes (X, Z). The welding device 12 is located in particular between the bars (16, 17). Thus, the torch 13 can be positioned perpendicular to the rail or switch gear to be repaired.

According to an alternative embodiment, the locking means on the switch gear comprise bars which are vertical or slightly tilted with respect to the vertical and on which the shoes (18, 19) can slide. In this configuration, the torch 13 can be arranged horizontally, towards a side face of the rail or switch gear, and not above it. This vertical configuration of the automat 10 is used for example for welding mobile crossing switches laterally.

The torch 13 is connected to a support 21 and to a supplying system 22 for core welding wires. A similar torch and a similar supplying system are described in particular in document EP 1 145 793.

In addition, the torch 13 and the frame 11 are electrically connected to an inverter (not represented) generating the electric welding arc.

The support 21 is provided with means for displacing the torch 13 with respect to the frame 11, over a certain distance in the direction of the horizontal axes (X, Y), as well as of the vertical axis Z. The distance the torch 13 can cover with respect to the frame 11 is for example 2000 mm in the direction of the axis X, 400 mm in the direction of the axis Y and 100 mm in the direction of the axis Z. These values are given as an indication only.

FIG. 2 shows a detailed view of the torch 13 and the support 21 represented in FIG. 1. The support 21 is connected in particular to a rack 50, arranged in the direction of the axis Z. A motor 51 makes it possible to move the support 21 and the torch 13 along the rack 50, by means of a toothed wheel 52. According to an alternative embodiment of the invention, the displacement in the direction of the axis Z is not controlled by a motor; the motor 51 is replaced by a system using a key for manually adjust the position of the torch in the direction of the axis Z. Such a system is described in document EP 1 145 793.

The rack 50 itself is connected to a rod 53 oriented in the direction of the axis Y. A motor 54 makes it possible to move the rack 50 along the rod 53, for example by means of a system using a rack or an endless screw.

The rod 53 itself is connected to the frame 11 so as to be mobile with respect to said frame in the direction of the axis X, via a system comprising a motor 56.

The welding operation is controlled by the unit 14 for driving and controlling the welding operation. The unit 14 is schematically represented in FIG. 3.

The unit 14 comprises in particular a device 30 for controlling the automat 10. The device 30 includes a microprocessor 31, a data memory 33, a program memory 32 and at least one communication bus 34.

By means of an interface 35, the device 30 is connected in particular to a keyboard 36 arranged on a front face of the unit 14. This keyboard enables an operator to transmit instructions to the device 30.

The device 30 is also connected to a position sensor 38, located on the torch 13.

The memory 32 contains a welding program 37, some characteristics of which will be described in details hereafter.

The program 37 sends instructions to the torch 13 and/or its support 21 via the interface 35. The program 37 can actuate in particular the motors (51, 54, 56) in order to move the torch in the direction of the axes X, Y and Z.

The device 30 also controls the inverter 60 generating the electric arc.

With such a unit 14 for driving and controlling the automat 10, a repair or maintenance operation for a rail or a switch gear such as the gear 15 is carried out for example in the following way:

First of all, an operator positions the automat 10 on the switch gear 15, as represented in FIG. 1. The operator then adjusts the position of the shoes (18, 19) of the frame with respect to the bars (16, 17), so that the torch 13 is substantially above an area of the switch gear 15 to be repaired. As an example, a top view of an area 40 to be repaired is represented in FIG. 4.

In the example represented in FIG. 4, the area 40 is located on a track crossing 41 belonging to the switch gear 15. The track crossing 41 comprises several worn surfaces (42, 43, 44) having thus recesses therein, for example due to train traffic. It is advisable to fill these recesses by means of a welding material supplied by the torch 13.

For this purpose, the operator positions the torch 13, provided with its position sensor 38, vertically to a point of reference Po. This point Po is located for example at the edge of a surface (42, 43, 44) or near one of these surfaces. Preferentially, the operator positions a lower end 55 of the torch into contact with the point Po.

To position the torch 13 into contact with the point Po, the operator moves the torch 13 with respect to the frame 11, for example by actuating the means of displacement (51, 54, 56) carried by the support 21. This actuation is done for example via the keyboard 36.

The position of the point Po with respect to the axes (X, Y, Z) is stored in the memory 33. This position is preferentially stored by actuating a control key on the keyboard 36 whereas the nose 55 of the torch is in contact with the point Po.

Then, with respect to the point Po and the axes (X, Y, Z), the operator stores the co-ordinates of a series of points P corresponding to the vertexes of polygons delimiting the surfaces (42, 43, 44) to be treated. These surfaces (42, 43, 44) can be juxtaposed or placed at a certain distance from one another.

In addition, a working surface (42, 43, 44) can be an unspecified polygon, defined by a number of points P equal to or higher than 3.

The co-ordinates of the surfaces (42, 43, 44) are preferentially stored by positioning the nose 55 of the torch into contact with each point P and by actuating simultaneously a control key of the keyboard 36.

Preferentially, the sensor 38 is able to determine the co-ordinates of each point P in the direction of the three axes (X, Y, Z), and not only of the axes (X, Y).

Indeed, it happens that the elements of switch gears such as track crossings 41 have three-dimensional surfaces. The surfaces (42, 43, 44) to be treated are not necessarily located in a horizontal plane.

According to an embodiment of the invention, the operator can preselect a direction of displacement of the torch 13 during a welding operation, for example in the direction of the axis X (longitudinal welding operation) or Y (transversal welding operation). This type of longitudinal or transversal welding operation is particularly adapted to rail welding.

According to another embodiment of the invention, during the storing of the co-ordinates of points P defining a surface 42, the operator can choose two points P defining a direction of displacement of the torch 13 during a welding operation. Such a direction can be unspecified with respect to the axes (X, Y) or (X, Y, Z). This embodiment is particularly adapted to switch gears, which can have particular shapes.

Before starting the welding program, the operator defines the welding parameters. These parameters are in particular the working voltage, the current, the wire unwinding speed and the speed of the torch with respect to the frame. Another parameter is the “stick-out”, i.e. the height of the torch with respect to the working surface, which corresponds to the height of the electric arc.

Preferentially, the memory 33 includes “melting profiles” 61 corresponding to each type of core welding wire identified by the device 30. Indeed, core welding wires are specifically developed according to the nature of the metal of the part to be welded. For each type of core welding wire, one can identify an optimal correlation between the definite welding parameters defined thereabove. These data are stored into the memory 33.

Thus, preferentially, the operator selects by means of a keyboard 36 the type of core welding wire the automat 10 is supplied with. Thus, the welding program 37 will automatically implement an optimal combination of parameters adapted to this type of wire.

According to an embodiment of the invention, for each type of wire, the program 37 implements an optimal default combination of parameters. The operator can choose to modify one of these parameters manually, for example the wire unwinding speed. The program 37 then adapts automatically the other parameters according to the profile 61.

When all the surfaces (42, 43, 44) are defined in a system of coordinates (Po, X, Y, Z) and the welding parameters are defined, the operator can start the welding program 37. This program implements the means of displacement (51, 54, 56) with respect to the frame 11 carried by the support 21, so as to position the torch vertically to a first working surface 42. A magnification of the surfaces (42, 43, 44) is represented in FIG. 5.

The torch 13 deposits a first weld seam 45 onto the surface 42. The travel speed of the torch and its supply by the system 22 are controlled by the program 37, according to the profile 61 in the memory 33. In the example represented in FIG. 5, the weld seam 45 is deposited in a rectilinear way, according to the axis X in order to correspond to a rolling direction of the switch gear 15.

According to an embodiment of the invention, the switch gear 15 is out of carbon steel. It is then desirable that the welding operation be carried out at a high temperature, in particular at a temperature higher than 300° C.

In this case, before depositing the first weld seam 45, the program 37 comprises a step of pre-heating the surface 42. Such a pre-heating process can be carried out by means of a air-gas burner or by magnetic induction.

After depositing the first weld seam 45, the torch 13 deposits a succession of weld seams 46 parallel to the surface 42, until covering it completely. Preferentially, two adjacent weld seams overlap partially. According to the individual case, one or more layers of metal can be deposited on the surface 42.

The same pre-heating and then covering operations are repeated on the other surfaces (43, 44).

Finishing operations, such as a grinding or machining operation, can then be carried out. Preferentially, during the welding operation, the program 37 controls the voltage and current of the electric arc, as well as the deposition rate of the filler metal, in order to optimize the volume of metal added to minimize the finishing operations. This regulation is carried out according to the data of the profile 61 of the wire used.

According to another embodiment of the invention, the switch gear 15 is out of cast manganese steel. It is then desirable that the welding operation be carried out at a relatively low temperature, in particular at a temperature lower than 250° C.

In this case, after depositing the first weld seam 45 onto the surface 42, the program 37 controls the displacement of the torch 13 above another surface 43 to be treated, said surface 43 being preferentially away from the surface 42. The torch 13 then deposits a weld seam 47 onto the surface 43, said weld seam being preferentially rectilinear and parallel to the weld seam 45. The torch then moves above another surface 44 and repeats the operation of depositing a weld seam.

When all the working surfaces (42, 43, 44) stored have received a first weld seam, the torch 13 deposits a second weld seam 46 onto the first surface 42.

The time between the deposition of the weld seams 45 and 46 enables the track crossing 41 to cool at the surface 42, so as to maintain its temperature below 250° C.

The operations of depositing weld seams onto each surface are repeated until all said surfaces are totally covered.

The working surfaces (42, 43, 44) are thus successively treated, one weld seam after another, so as to be able to cool between the depositions of the weld seams.

Finishing operations, such as a grinding or machining operation, can then be carried out. Preferentially, during the welding operation, the program 37 controls the voltage and current of the electric arc, as well as the deposition rate of the filler metal, in order to optimize the volume of metal added to minimize the finishing operations.

According to an alternative embodiment of the invention, during the welding operation, the torch moves in a rectilinear main direction—for example in the direction of the axis X—and moreover performs a back and forth movement over a certain distance in the direction of the axis Y. One then obtains a weld seam having a sinusoidal or crenellated shape.

Such an oscillating movement makes it possible to obtain a flatter deposition on the working surfaces, by adjusting the speed of the oscillations with respect to the travel speed of the torch in its main direction and the wire unwinding speed. Such a flatter deposition limits the grinding operations with respect to a rectilinear weld seam, which in general has a convex shape.

According to an embodiment of the invention, the automat 10 comprises a temperature sensor which makes it possible to measure the temperature of the rail or the switch gear during the welding operation.

A temperature sensor 39 (FIG. 3) is supported for example by the torch 13 and connected to the control device 30, via the interface 35. It is preferentially an infra-red sensor.

In the case of a welding operation using carbon steel, the sensor 39 can for example control that the working surface is sufficiently hot, for example above 300° C., before starting the deposition of a weld seam.

Such a control of the temperature is also useful in the case of a track crossing out of manganese steel, in order to control that the metal temperature does not exceed a predetermined threshold, for example 250° C. the program 37 can in particular delay the deposition of a second weld seam 46 onto a working surface 42 as long as the first weld seam 45 has not become cool enough.

An automat according to the invention is adapted to the maintenance and the repair of any type of rail and/or switch gear, in particular of rails for railway trains, tramways or subways. The welding operations can be carried out inside a workshop, but also outside on site, without it being necessary to remove the rails and/or switch gears to be repaired.

1. Method for welding a localized area (40) of a rail or a swing gear (15), the method including the following steps of:
positioning along at least one rail or an swing gear (15) an electric arc welding automat (10), said apparatus including a frame (11) and a welding torch (13) supplied with core welding wire, said torch being provided with means (54, 56) of displacement in the direction of at least two dimensions with respect to the frame;
placing the torch into a position of reference (Po) with respect to the area to be welded;
storing, in a reference system having at least two dimensions (X, Y), the space co-ordinates of points (P) forming at least two polygons defining at least two distinct working surfaces (42, 43, 44) inside the area to be welded;
starting a welding program (37) involving a displacement of the torch with respect to the frame, so as to intervene successively on the unit of said distinct working surfaces.

2. Method according to claim 1, characterized in that:
the space co-ordinates of the working surfaces are defined in a reference system having three dimensions (X, Y, Z);
the torch (13) is provided with means (51, 54, 56) of displacement in three dimensions with respect to the frame (11).

3. Method according to claim 1, characterized in that, during the welding operation, the displacement of the torch is such as:
the torch successively deposits a first weld seam (45, 47) onto each distinct working surface (42, 43, 44);
then the torch successively deposits another weld seam (46) onto each said working surface not entirely covered;
said last step being repeated as long as at least one of the working surfaces is not entirely covered.

4. Method according to claim 3, wherein the weld seams deposited by the torch are rectilinear and substantially parallel to the same main direction of displacement of the torch.

5. Method according to claim 4, wherein before starting the welding program (37) two points (P) are selected whose co-ordinates determine a main direction of displacement of the torch during the welding operation.

6. Electric arc welding automat (10) for maintaining or repairing rails and switch gears, the automat including a frame (11), a welding device (12) including a welding torch (13), the frame being provided with at least two means (16, 17) for the support on a rail or a switch gear,
the torch including means (54, 56) of displacement on at least two horizontal axes,
the automat being characterized in that it is provided with means (14, 37) making it possible to carry out the following steps of:
storing, in a reference system having at least two dimensions, space co-ordinates of points (P) forming at least two polygons defining at least two distinct working surfaces (42, 43, 44) inside an area (40) to be welded;
implementing a welding program (37) including a displacement of the torch with respect to the frame, so as to intervene successively on all said distinct working surfaces.

7. Automat according to claim 6, wherein:
the torch is provided with means (51, 54, 56) of displacement in the direction of two horizontal axes and one vertical axis;
the space co-ordinates of the working areas are defined in a reference system having three dimensions.

8. Automat according to claim 5, wherein the welding program controls welding parameters according to characteristics (61) stored in a memory (33) and corresponding specifically to the core welding wire the automat is provided with, said welding parameters including the parameters chosen among the working voltage, the current, the unwinding speed of the core welding wire, the travel speed of the torch with respect to the frame and the height of the electric arc.

9. Automat according to claim 5, wherein:
it includes a temperature sensor (39) making it possible to measure the temperature of the rail or the switch gear during the welding operation;
the welding program (37) allows the deposition of a weld seam only if the temperature of the rail is in a determined range according to the type of metal of the area to be welded.

10. Method according to claim 2, characterized in that, during the welding operation, the displacement of the torch is such as:
the torch successively deposits a first weld seam (45, 47) onto each distinct working surface (42, 43, 44);
then the torch successively deposits another weld seam (46) onto each said working surface not entirely covered;
said last step being repeated as long as at least one of the working surfaces is not entirely covered.

11. Automat according to claim 6, wherein the welding program controls welding parameters according to characteristics (61) stored in a memory (33) and corresponding specifically to the core welding wire the automat is provided with, said welding parameters including the parameters chosen among the working voltage, the current, the unwinding speed of the core welding wire, the travel speed of the torch with respect to the frame and the height of the electric arc.

12. Automat according to claim 7, wherein the welding program controls welding parameters according to characteristics (61) stored in a memory (33) and corresponding specifically to the core welding wire the automat is provided with, said welding parameters including the parameters chosen among the working voltage, the current, the unwinding speed of the core welding wire, the travel speed of the torch with respect to the frame and the height of the electric arc.

13. Automat according to claim 6, wherein:
it includes a temperature sensor (39) making it possible to measure the temperature of the rail or the switch gear during the welding operation;
the welding program (37) allows the deposition of a weld seam only if the temperature of the rail is in a determined range according to the type of metal of the area to be welded.

14. Automat according to claim 7, wherein:
it includes a temperature sensor (39) making it possible to measure the temperature of the rail or the switch gear during the welding operation;
the welding program (37) allows the deposition of a weld seam only if the temperature of the rail is in a determined range according to the type of metal of the area to be welded.
